(19) United States
(12) Patent Application Publication
(10) Pub. No.: US 2022/0350051 A1
(43) Pub. Date: Nov. 3, 2022

(54) GLASS AND PLASTIC HYBRID LENS

(71) Applicant: Facebook Technologies, LLC, Menlo Park, CA (US)

(72) Inventors: Sho Nakahara, Redmond, WA (US); Kurt Jenkins, Sammamish, WA (US); Carl Chancy, Seattle, WA (US)

(21) Appl. No.: 17/246,270

(22) Filed: Apr. 30, 2021

(51) Int. Cl. G02B 1/04; G02B 1/14; G02B 3/00

(52) U.S. Cl. CPC G02B 1/041; G02B 1/14; G02B 3/00; G02B 2003/0093

(57) ABSTRACT

A lens includes a glass layer and a plastic layer. The glass layer has a first glass side disposed opposite of a second glass side. The plastic layer has a first plastic side disposed opposite of a second plastic side. The first plastic side of the plastic layer is bonded to the second glass side of the glass layer. The outside plastic boundary of the plastic layer extends past an outside glass boundary of the glass layer.

### TECHNICAL FIELD

This disclosure relates generally to optics, and in particular to lenses.

### BACKGROUND INFORMATION

Prescription lenses were traditionally fabricated out of glass before transitioning to predominantly plastic lenses. The conventional manufacturing technique for prescription lenses is to form a prescription surface specific to an individual from a plastic blank that has a base curve. This technique works well for fabricating traditional eye glasses, although the thickness and weight of traditional prescription lenses constrain design, in some contexts.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A illustrates a side view of a hybrid glass-plastic lens, in accordance with aspects of the disclosure.

FIG. 1B illustrates a front view of the hybrid-plastic lens that includes a glass layer and a plastic layer, in accordance with aspects of the disclosure.

FIG. 2A illustrates a side view of another hybrid glass-plastic lens, in accordance with aspects of the disclosure.

FIG. 2B illustrates a front view of the lens illustrated in FIG. 2A, in accordance with aspects of the disclosure.

FIG. 3 illustrates a process of fabricating a lens that includes a mold, in accordance with aspects of the disclosure.

FIGS. 4A-4H illustrate example fabrication techniques for fabricating a lens utilizing a mold, in accordance with aspects of the disclosure.

FIG. 5 illustrates a process of fabricating a lens that includes bonding, in accordance with aspects of the disclosure.

FIGS. 6A-6C illustrate example bonding techniques for fabricating a lens, in accordance with aspects of the disclosure.

FIG. 7 illustrates an example head mounted device that may include a hybrid glass-plastic lens, in accordance with aspects of the disclosure.

### DETAILED DESCRIPTION

Embodiments of glass and plastic hybrid lens are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.4 μm.

In aspects of this disclosure, the term “transparent” may be defined as having greater than 90% transmission of light. In some aspects, the term “transparent” may be defined as a material having greater than 80% transmission of visible light.

Aspects of this disclosure are directed to a lens that includes a glass layer and a plastic layer. Conventional lenses have been either all glass or all plastic for ease of manufacturing. The glass layer may be a pre-formed glass element to provide structural support and mechanical rigidity while the plastic portion reduces the overall weight of the lens. The glass layer may be strengthened glass. The glass layer may have optical or display functions.

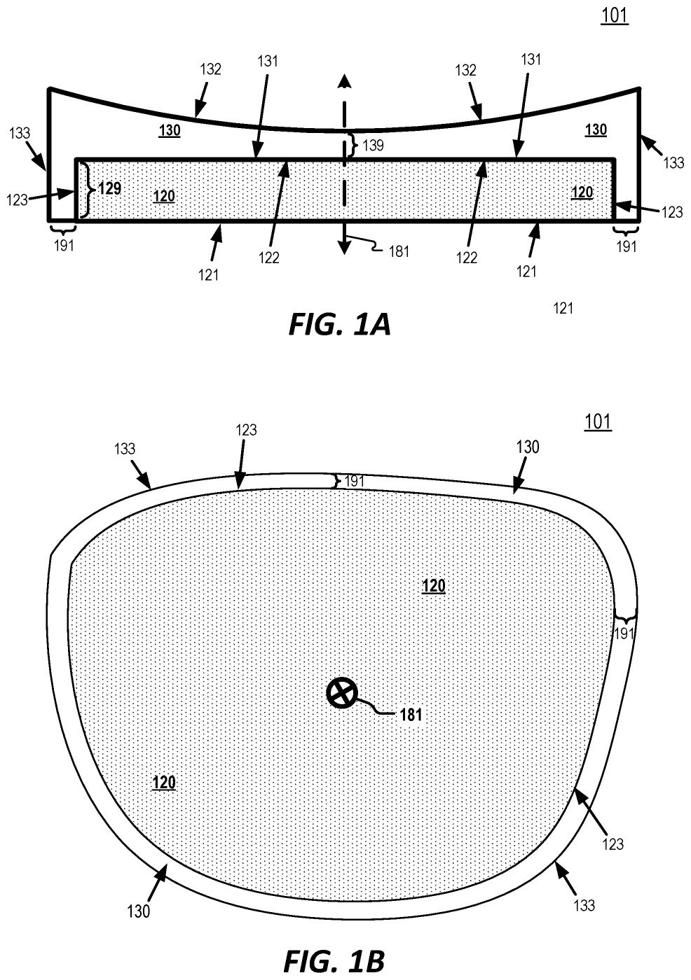

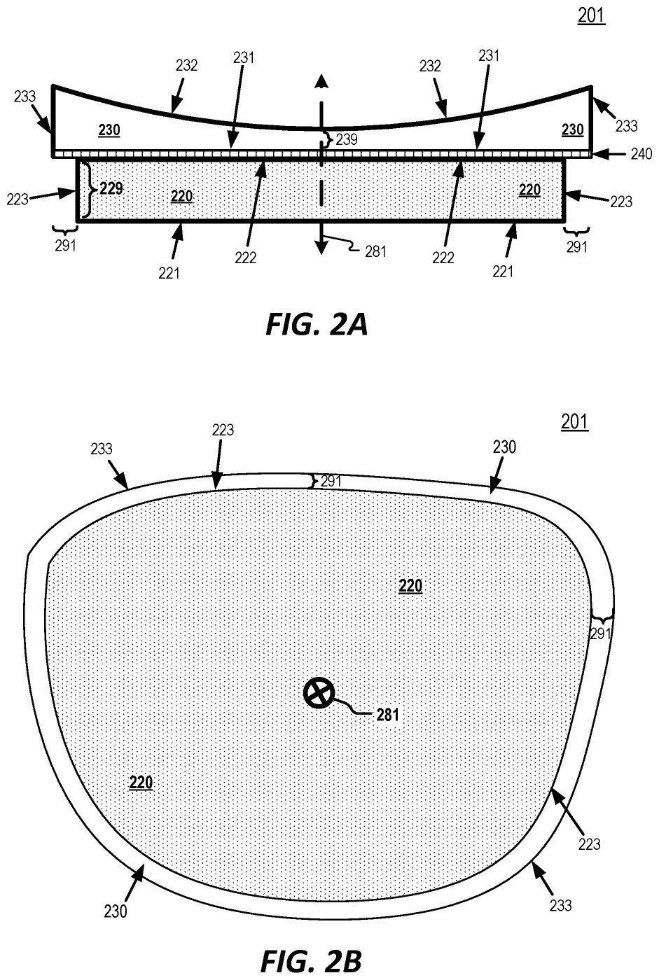

Lenses are typically “edged” to form the lens into a lens shape suitable for eyeglasses. However, in a glass lens, edging glass may cause chipping or cracking of the glass. With a glass-plastic lens, edging the glass portion of the lens is also susceptible to chipping, cracking, and separating the glass portion from the plastic portion of the lens. In implementations of the disclosure, an outside boundary of a plastic layer extends past the outside boundary of the glass layer so that the plastic layer can be edged into the lens shape without risking edging the glass layer. A prescription surface may be formed in the plastic layer to provide an ophthalmic lens that focuses light to the retina for a specific user. The rigidity of the glass layer may also allow for adding additional optical layers to the lens while maintaining design tolerances. For example, in a particular context of augmented reality (AR) or virtual reality (VR), a display layer or an eye-tracking layer is bonded to the glass layer of the glass-plastic hybrid lens. These and other embodiments are described in more detail in connection with FIGS. 1A-7.

FIG. 1A illustrates a side view of a hybrid glass-plastic lens 101, in accordance with aspects of the disclosure. Lens 101 may be an ophthalmic lens for correcting vision in persons where the focal point of the eye does not focus image light onto their retina. Lens 101 includes a glass layer 120 and a plastic layer 130. Glass layer 120 has a first glass side 121 disposed opposite of a second glass side 122. Glass layer 120 may have a thickness 129. Thickness 129 may be between 100 microns and 1000 microns, for example. First glass side 121 may be planar. A planar surface on first glass side 121 may facilitate bonding additional optical components to glass layer 120. In some implementations, first glass side 121 is shaped to provide optical power.

Glass layer 120 may be strengthened glass. “Strengthened glass” may be heat strengthened or chemically strengthened. Heat strengthened glass has increased strength as a result of heating glass beyond its softening point and then cooling it down rapidly, whereas chemically strengthened glass has increased strength as a result of post-product chemical process. One example of chemically strengthened glass is an alkali-aluminosilicate glass which gains strength by immersion in a potassium salt bath where larger potassium ions are exchanged. In one example, glass layer 120 includes a soda lime glass.

Plastic layer 130 includes a first plastic side 131 disposed opposite of a second plastic side 132. The first plastic side 131 is bonded to the second glass side 122 of glass layer 120. First plastic side 131 may be “bonded” to second glass side 122 by overmolding a polymer onto glass layer 120, in some implementations. The refractive index of glass layer 120 may have the same index of refraction as the refractive index of plastic layer 130. An outside plastic boundary 133 of plastic layer 130 extends past an outside glass boundary 123 of glass layer 120. Plastic layer 130 extends a width 191 past the outside glass boundary 123 of glass layer 120, in FIG. 1A. Width 191 may be approximately 0.5 mm. Width 191 may be greater than 0.5 mm. Width 191 may be approximately 1 mm. In the particular implementations of FIG. 1A, plastic layer 130 surrounds the outside glass boundary 123 of glass layer 120.

A prescription surface to focus light to an eye of an individual may be formed in the second plastic side 132. A thickness 139 of the plastic layer 130 through an optical axis 181 of the prescription surface may be 50 microns. The mechanical rigidity of the glass layer 120 may allow for such a shallow thickness 139 of plastic layer 130 in lens 101. In some implementations, thickness 139 may be 100 microns. Thickness 139 may be between 50 microns and 2 mm, depending on prescription requirements.

FIG. 1B illustrates a front view of lens 101 that includes glass layer 120 and plastic layer 130, in accordance with implementations of the disclosure. An outside plastic boundary 133 of plastic layer 130 extends past the outside glass boundary 123 of glass layer 120. The outside plastic boundary 133 is offset from outside glass boundary 123 by width 191. FIG. 1B illustrates an optical axis 181 of a prescription surface of the second plastic side 132 of plastic layer 130 going into the page. The outside plastic boundary 133 of lens 101 may be edged to a lens shape that is for a specific frame of glasses and lens 101 may be secured to the frame of the glasses by the outside plastic boundary 133.

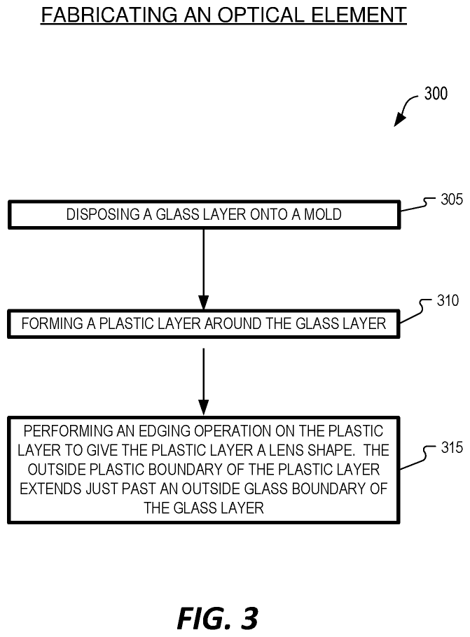

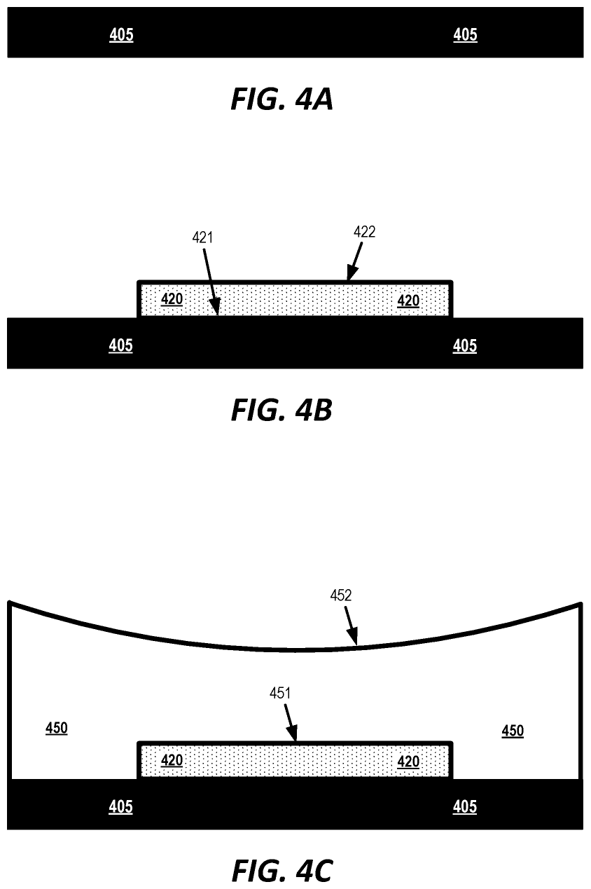

FIG. 2A illustrates a side view of a hybrid glass-plastic lens 201, in accordance with aspects of the disclosure. Lens 201 may be fabricated using a lamination fabrication technique. Lens 201 may be an ophthalmic lens for correction vision in persons where the focal point of the eye does not focus image light onto their retina. Lens 201 includes a glass layer 220 and a plastic layer 230. Glass layer 220 has a first glass side 221 disposed opposite of a second glass side 222. Glass layer 220 may have a thickness 229. Thickness 229 may be between 100 microns and 1000 microns, for example. First glass side 221 may be planar. A planar surface on first glass side 221 may facilitate bonding additional optical components to glass layer 220. In some implementations, first glass side 221 is shaped to provide optical power. Glass layer 220 may be strengthened glass.

Plastic layer 230 includes a first plastic side 231 disposed opposite of a second plastic side 232. The first plastic side 231 is bonded to the second glass side 222 of glass layer 220. In the illustrated implementation, first plastic side 231 is bonded to the second glass side 222 by way of a bonding layer 240. Bonding layer 240 may be optically clear adhesive (OCA) or liquid optically clear adhesive (LOCA) cured by UV or thermal, in some implementations. The refractive index of glass layer 220 may have a same index of refraction as the refractive index of plastic layer 230. An outside plastic boundary 233 of plastic layer 230 extends past an outside glass boundary 223 of glass layer 220. Plastic layer 230 extends a width 291 past the outside glass boundary 223 of glass layer 220. Width 291 may be approximately 0.5 mm. Width 291 may be greater than 0.5 mm. Width 291 may be approximately 1 mm. In the particular implementations of FIG. 2A, bonding layer 240 extends the width 291 past the outside of outside glass boundary 233.

A prescription surface to focus light to an eye of an individual may be formed in the second plastic side 232. A thickness 239 of the plastic layer 230 through an optical axis 281 of the prescription surface may be 50 microns. The mechanical rigidity of the glass layer 220 may allow for such a shallow thickness 239. In some implementations, thickness 239 may be 100 microns. Thickness 239 may be between 50 microns and 2 mm, depending on the required prescription.

FIG. 2B illustrates a front view of lens 201 that includes glass layer 220 and plastic layer 230, in accordance with implementations of the disclosure. An outside plastic boundary 233 of plastic layer 230 extends past the outside glass boundary 223 of glass layer 220. The outside plastic boundary 233 is offset from outside glass boundary 223 by width 291. FIG. 2B illustrates an optical axis 281 of a prescription surface of the second plastic side 232 of plastic layer 230 going into the page. The outside plastic boundary 233 of lens 201 may be edged to a lens shape that is for a specific frame of glasses and lens 201 may be secured to the frame of the glasses by the outside plastic boundary 233.

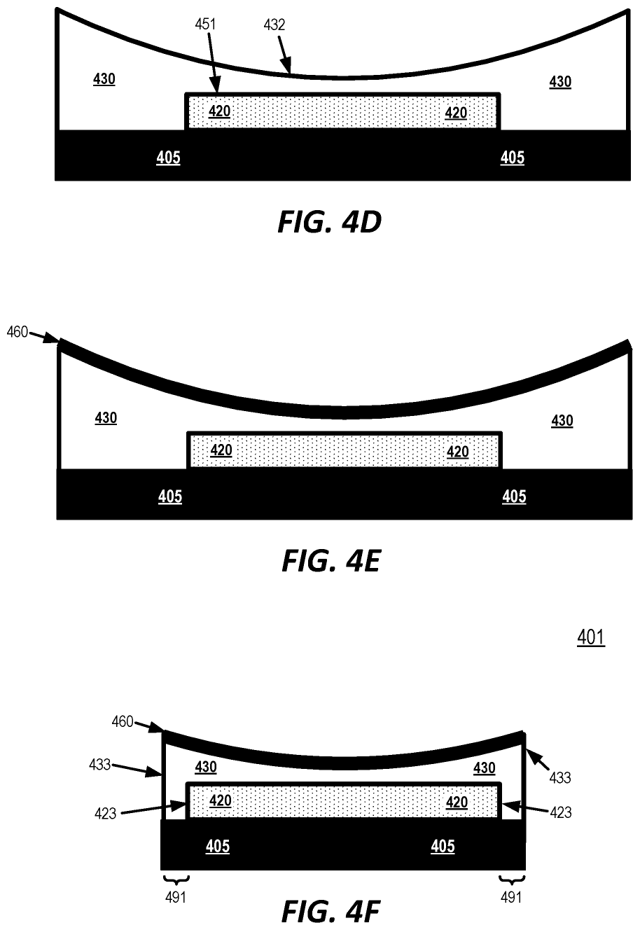

FIG. 3 illustrates a process 300 of fabricating a lens that includes a mold, in accordance with aspects of the disclosure. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel. Process 300 may be used to fabricate lens 101, for example.

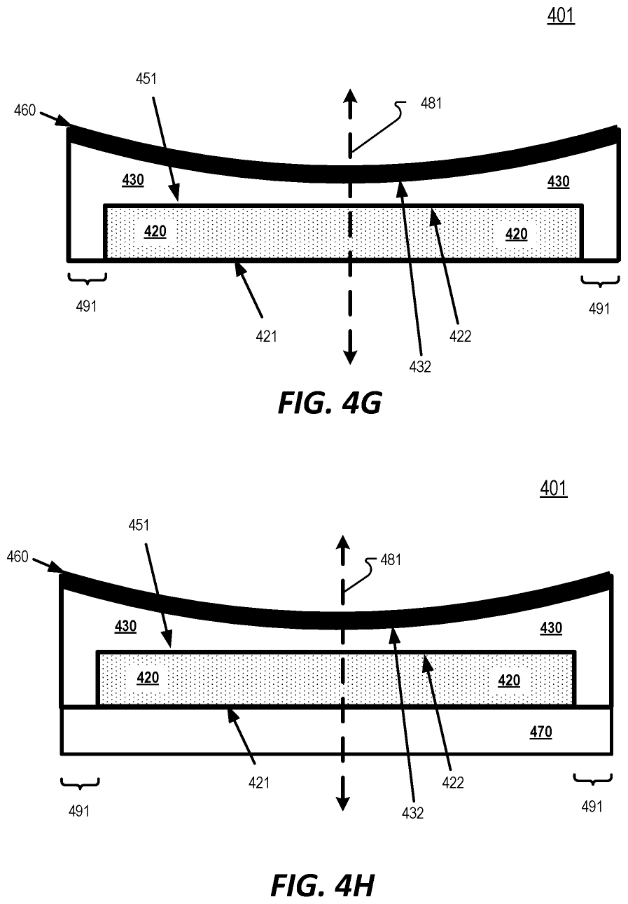

In process block 305, a glass layer is disposed onto a mold. FIG. 4A shows an example mold element 405 and FIG. 4B illustrates glass layer 420 on mold element 405, for example. Glass layer 420 may have the attributes described in connection with glass layer 120. Glass layer 420 includes a first glass side 421 and a second glass side 422.

Referring back to FIG. 3, a plastic layer is formed around glass layer 420, in process block 310. FIG. 4C illustrates an example plastic layer 450 formed around glass layer 420. A second mold element (not illustrated) may be used to define the boundaries of plastic layer 450. Plastic layer 450 includes a first plastic side 451 disposed opposite of a second plastic side 452. Second plastic side 452 may include a base curvature as a starting surface to forming a prescription surface in a subtractive process (e.g. diamond turning the prescription surface including polishing the surface after diamond turning). FIG. 4D illustrates that a portion of plastic layer 450 has been removed to leave plastic layer 430 having a second plastic side 432 disposed opposite of the first plastic side 451. A prescription surface is formed in the second plastic side 432 in a subtractive process, for example. FIG. 4E illustrates that one or more optical layers 460 may be formed on the second plastic side 432. Optical layer 460 may be a hard-coat layer, an anti-reflective (AR) layer or a functional layer such as UV or blue light cut layer, or a color layer, for example.

Referring back to process 300 of FIG. 3, an edging operation is performed on plastic layer 430 to give the plastic layer a lens shape, in process block 315. The lens shape may be shaped to align and be secured to a frame of glasses. The edging operation on the plastic layer leaves an outside plastic boundary of the plastic layer extending just past an outside glass boundary of the glass layer. Edging operation on plastic layer 430 can be made by a dry blade edger or wet wheel edger including grinding and polish and bevel steps. In some implementations, the edging operation on the plastic layer 430 can be made by a computer numerical control (CnC) edge cutting to get a special edge thickness and edge shape that is in line or smaller than the glass shape.

FIG. 4F illustrates optical element 401 after an edging operation is performed on the plastic layer 430. After the edging operation, outside plastic boundary 433 defines the lens shape of optical element 401. Glass layer 420 is not affected by the edging operation and plastic layer 430 extends past outside glass boundary 423 by dimension 491. In the specific illustration of FIG. 4F, mold element 405 is also edged so that the mold element 405 has the same lens shape as plastic layer 430 where the lens shape is defined by the outside plastic boundary 433.

FIG. 4G illustrates that mold element 405 has been removed from optical element 401. Axis 481 runs through the optical axis of a prescription surface 432 of optical element 401. FIG. 4H illustrates that an additional optical layer 470 is bonded to the first glass side 421 of glass layer 420. The additional optical layer 470 may be a display layer or an eye-tracking layer in the context of a head mounted device, for example.

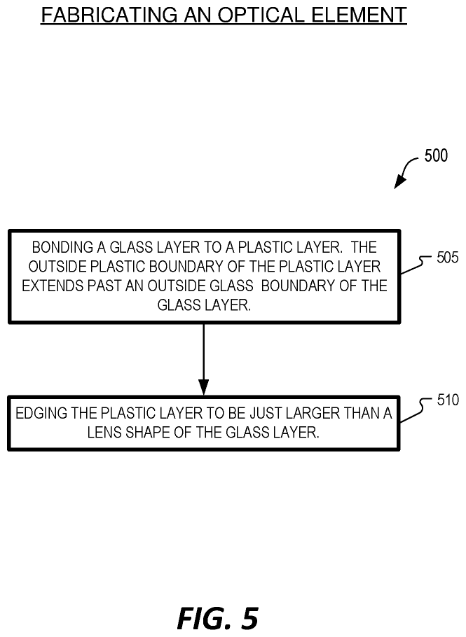

FIG. 5 illustrates a process 500 of fabricating a lens that includes bonding, in accordance with aspects of the disclosure. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel. Process 500 may be used to fabricate lens 201, for example.

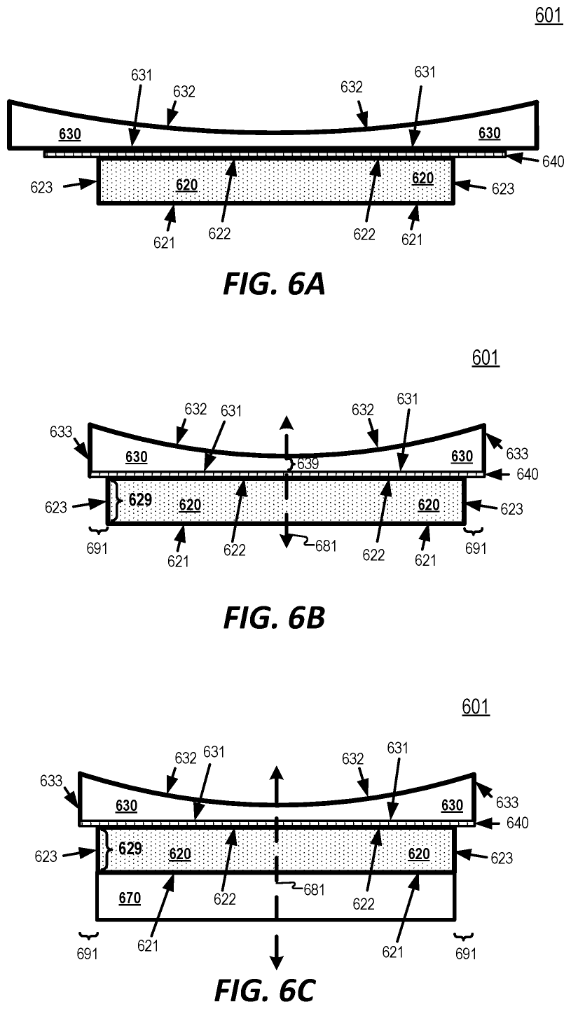

In process block 505, a glass layer is bonded to a plastic layer and an outside plastic boundary of the plastic layer extends past an outside glass boundary of the glass layer. FIG. 6A shows glass layer 620 bonded to plastic layer 630 to form optical element 601, for example. In the specific illustration of FIG. 6A, glass layer 620 is bonded to plastic layer 630 by way of bonding layer 640. Bonding layer 640 may be an optically clear adhesive (OCA) or a liquid optically clear adhesive (LOCA) cured by UV or thermal. Bonding layer 640 is illustrated as extending past the outside glass boundary 623 in FIG. 6A, although in some implementations, bonding layer 640 does not extend past outside glass boundary 623.

Glass layer 620 may have the attributes described in connection with glass layer 220. Glass layer 620 includes a first glass side 621 and a second glass side 622. Plastic layer 630 includes a first plastic side 631 disposed opposite of a second plastic side 632. Second plastic side 632 may include a base curvature as a starting surface to forming a prescription surface in a subtractive process (e.g. diamond turning the prescription surface). In other implementations, second plastic side 632 already has a prescription surface formed in second plastic side 632, prior to bonding to glass layer 620. While not specifically illustrated, one or more optical layers similar to optical layer 460 may be formed on the second plastic side 632.

Referring back to process 500 of FIG. 5, the plastic layer is edged to be just larger than a lens shape of the glass layer, in process block 510. FIG. 6B illustrates that plastic layer 630 has been edged so that it is just larger than a lens shape of glass layer 620 that is defined by the outside glass boundary of glass layer 620. In the particular implementation of FIG. 6B, bonding layer 640 is also edged in the edging operation so that bonding layer 640 is even with the outside plastic boundary 633 of plastic layer 630 so that both the plastic layer 630 and the bonding layer 640 are offset from the outside glass boundary 623 by dimension 691. Dimension 691 may be between 0.5 mm and 1 mm, in some implementations. In an implementation, a thickness 639 of plastic layer 630 through an optical axis 681 of the prescription surface 632 of plastic layer 630 is between 50 microns and 100 microns. In an implementation, a thickness 639 of plastic layer 630 through an optical axis 681 of the prescription surface 632 of plastic layer 630 is between 50 microns and 500 microns.

FIG. 6C illustrates that an additional optical layer 670 is bonded to the first glass side 621 of glass layer 620. The additional optical layer 670 may be a display layer or an eye-tracking layer in the context of a head mounted device, for example.

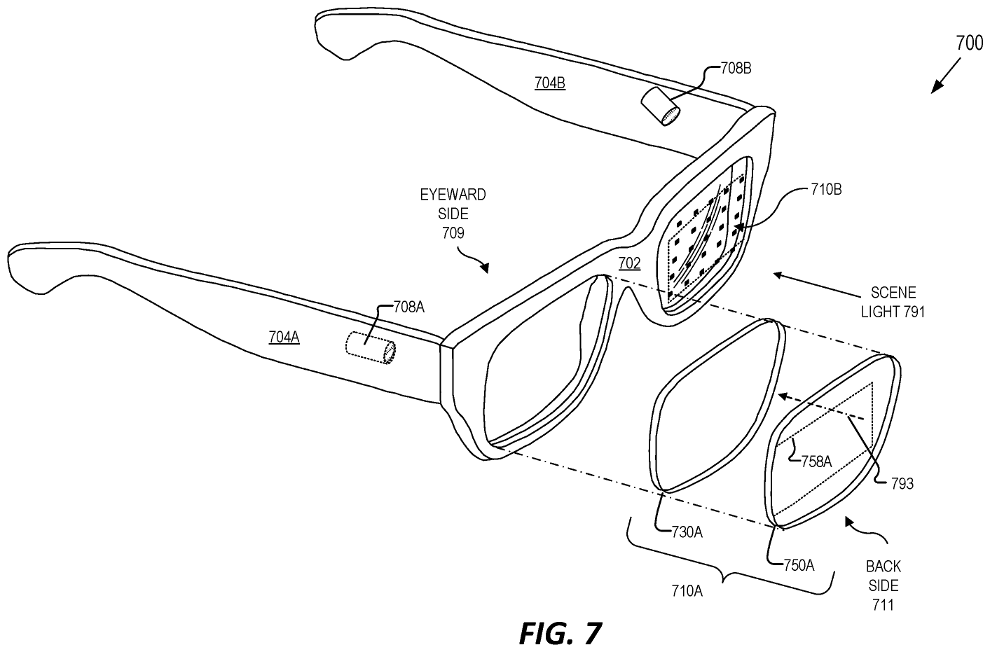

FIG. 7 illustrates an example head mounted device 700 that includes a hybrid glass-plastic lens, in accordance with aspects of the present disclosure. The illustrated example of head mounted device 700 is shown as including a frame 702, temple arms 704A and 704B, and near-eye optical elements 710A and 710B. Head mounted device 700 is worn on or about a head of a user. Head mounted device 700 may include a display such that head mounted device 700 is considered a pair of augmented-reality glasses. Implementations of this disclosure may also be implemented in a virtual reality headset, electronic glasses, or non-electronic eye glasses. Eye-tracking cameras 708A and 708B are shown as coupled to temple arms 704A and 704B, respectively. FIG. 7 also illustrates an exploded view of an example of near-eye optical element 710A. Near-eye optical element 710A is shown as including an optical element 730A and a display layer 750A. Lens 101 or 201 may be used as optical element 730A, in various implementations. Display layer 750A may be bonded to optical element 730A. Display layer 750A may include a waveguide 758 that is configured to direct virtual images to an eye of a user of head mounted device 700.

In some implementations (not illustrated), an eye-tracking layer is bonded to optical element 730A. The eye-tracking layer may include a plurality of in-field light sources (e.g. near-infrared vertical-cavity surface-emitting lasers) for illuminating an eyebox area and an optical combiner for directing near-infrared images to be imaged by eye-tracking camera(s) 704.

As shown in FIG. 7, frame 702 is coupled to temple arms 704A and 704B for securing the head mounted device 700 to the head of a user. Near-eye optical element 710A may be secured to frame 702 by a plastic layer (e.g. 130 or 230) of the optical element 730A.

Example head mounted device 700 may also include supporting hardware incorporated into the frame 702 and/or temple arms 704A and 704B. The hardware of head mounted device 700 may include any of processing logic, wired and/or wireless data interface for sending and receiving data, graphic processors, and one or more memories for storing data and computer-executable instructions. In one example, head mounted device 700 may be configured to receive wired power and/or may be configured to be powered by one or more batteries. In addition, head mounted device 700 may be configured to receive wired and/or wireless data including video data.

FIG. 7 illustrates near-eye optical elements 710A and 710B that are configured to be mounted to the frame 702. In some examples, near-eye optical elements 710A and 710B may appear transparent to the user to facilitate augmented reality or mixed reality such that the user can view visible scene light from the environment while also receiving display light 793 directed to their eye(s) by way of display layer 750A. In further examples, some or all of near-eye optical elements 710A and 710B may be incorporated into a virtual reality headset where the transparent nature of the near-eye optical elements 730A and 730B allows the user to view an electronic display (e.g., a liquid crystal display (LCD), an organic light emitting diode (OLED) display, a micro-LED display, etc.) incorporated in the virtual reality headset.

Display layer 750A may include one or more other optical elements depending on the design of the head mounted device 700. For example, the display layer 750A may include a waveguide 758 to direct display light 793 generated by an electronic display to the eye of the user. In some implementations, at least a portion of the electronic display is included in the frame 702 of the head mounted device 700. The electronic display may include an LCD, an organic light emitting diode (OLED) display, micro-LED display, pico-projector, or liquid crystal on silicon (LCOS) display for generating the display light 793. In some embodiments, near-eye optical elements 710 may not include a display and may be included in a head mounted device that is not considered a head mounted display.

Optical layer 730A may have a lens curvature for focusing light (e.g., display light 793 and/or scene light 791) to the eye of the user on the eyeward side 709 of the near-eye optical element 710A. In some aspects, the optical layer 730A has a thickness and/or curvature that corresponds to the specifications of a user. In other words, optical layer 730A may be a prescription lens. Thus, the optical layer 730A may, in some examples, may be referred to as an ophthalmic lens. However, in other examples, optical layer 730A may be a non-prescription lens.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The term “processing logic” in this disclosure may include one or more processors, microprocessors, multi-core processors, Application-specific integrated circuits (ASIC), and/or Field Programmable Gate Arrays (FPGAs) to execute operations disclosed herein. In some embodiments, memories (not illustrated) are integrated into the processing logic to store instructions to execute operations and/or store data. Processing logic may also include analog or digital circuitry to perform the operations in accordance with embodiments of the disclosure.

A “memory” or “memories” described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

Communication channels may include or be routed through one or more wired or wireless communication utilizing IEEE 802.11 protocols, BlueTooth, SPI (Serial Peripheral Interface), I²C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An optical lens comprising:
a glass layer having a first glass side disposed opposite of a second glass side; and
a plastic layer having a first plastic side disposed opposite of a second plastic side, wherein the first plastic side of the plastic layer is bonded to the second glass side of the glass layer, and wherein an outside plastic boundary of the plastic layer extends past an outside glass boundary of the glass layer.

2. The optical lens of claim 1, wherein the second plastic side is a prescription optical surface to focus light to an eye of a user.

3. The optical lens of claim 2, wherein a thickness of the plastic layer through an optical axis of the prescription optical surface of the plastic layer is between 50 microns and 500 microns.

4. The optical lens of claim 1, wherein the first glass side is planar, and wherein the glass layer has a thickness between 100 microns and 1000 microns.

5. The optical lens of claim 1, wherein the plastic layer surrounds the outside glass boundary of the glass layer.

6. The optical lens of claim 1, wherein the plastic layer extends greater than 0.5 mm past the outside glass boundary of the glass layer.

7. The optical lens of claim 1, wherein the plastic layer extends greater than 1 mm past the outside glass boundary of the glass layer.

8. The optical lens of claim 1 further comprising:
an optically clear adhesive (OCA) disposed between the glass layer and the plastic layer to bond the glass layer to the plastic layer.

9. The optical lens of claim 1, wherein the glass layer is strengthened glass.

10. The optical lens of claim 1, wherein the plastic layer shape is equal the outside glass boundary of the glass layer shape.

11. The optical lens of claim 1, wherein the plastic layer shape is smaller than the outside glass boundary of the glass layer shape.

12. The optical lens of claim 1, wherein the first glass side provides optical power.

13. A method of fabricating an optical lens, the method comprising:
disposing a glass layer onto a mold, wherein the glass layer has a first glass side disposed opposite of a second glass side;
forming a plastic layer around the glass layer, wherein a first plastic side of the plastic layer is disposed opposite of a second plastic side of the plastic layer, the first plastic side being disposed between the second plastic side and the second glass side; and
performing an edging operation on the plastic layer to give the plastic layer a lens shape, wherein the edging operation leaves an outside plastic boundary of the plastic layer extending just past an outside glass boundary of the glass layer.

14. The method of claim 13 further comprising:
forming a prescription optical surface into the second plastic side of the plastic layer, wherein forming the prescription optical surface is a subtractive process.

15. The method of claim 13, wherein the second plastic side of the plastic layer includes a base curvature prior to forming the prescription optical surface.

16. The method of claim 13, wherein the edging operation is also performed on the mold so that the mold also has the lens shape of the plastic layer.

17. The method of claim 13 further comprising removing the mold from the glass layer subsequent to edging the mold and the plastic layer.

18. A method of fabricating an optical lens, the method comprising:
bonding a glass layer to a plastic layer, wherein an outside plastic boundary of the plastic layer extends past an outside glass boundary of the glass layer; and
edging the plastic layer to a just larger than a lens shape of the glass layer with the outside plastic boundary of the plastic layer extending between 0.5 mm and 1 mm past the outside glass boundary of the glass layer.

19. The method of claim 18 further comprising:
forming a prescription surface in a second plastic side of the plastic layer disposed opposite of a first plastic side of the plastic layer disposed between the second plastic side and the glass layer, wherein edging the plastic layer is subsequent to forming the prescription surface in the second plastic side of the plastic layer.

20. The method of claim 18, wherein a thickness of the plastic layer through an optical axis of the prescription surface of the plastic layer is between 50 microns and 500 microns.

21. The method of claim 18, wherein the glass layer has a thickness between 100 microns and 1000 microns.
